(19) United States
(12) Patent Application Publication
(10) Pub. No.: US 2006/0002833 A1
(43) Pub. Date: Jan. 5, 2006

(54) Apparatus to suppress ascending gas flow and method for exhaust control thereof

(76) Inventors: Hyung-Seok Choi, Yongin-si (KR); Jung-Sung Hwang, Suwon-si (KR); Kyoung-Ho Park, Suwon-si (KR); Kil-Sun Ko, Osan-si (KR); Yong-Woon Oh, Youngin-si (KR)

Correspondence Address: HARNESS, DICKEY & PIERCE, P.L.C., P.O. BOX 8910, RESTON, VA, 20195, US

(21) Appl. No.: 11/150,208

(22) Filed: Jun. 13, 2005

(30) Foreign Application Priority Data
Jul. 1, 2004 (KR) 2004-51178

(51) Int. Cl. B01J 8/04

(52) U.S. Cl. 422/188

(57) ABSTRACT

An apparatus and method for exhaust control. The apparatus may include a vessel to accommodate a gas flow of a gas, a sensor mounted on the vessel to sense a direction of the gas flow in the vessel, a conduit coupled to the vessel to exhaust the gas from the vessel, and a control unit that adjusts a flow rate of the gas through the conduit based on the direction of the gas flow in vessel sensed by the sensor. The method may include providing a gas flow of a gas in a vessel, sensing a direction of the gas flow in the vessel, exhausting the gas from the vessel at an exhaust flow rate, and adjusting the exhaust flow rate based on the sensed direction of the gas flow in the vessel.

### PRIORITY STATEMENT

This U.S. non-provisional application claims priority under 35 U.S.C. §119 from Korean Patent Application No. 2004-51178, filed on Jul. 1, 2004 in the Korean Intellectual Property Office, the disclosure of which is incorporated herein in its entirety by reference.

### BACKGROUND

1. Field of the Invention

The present invention relates in general to a semiconductor manufacturing apparatus and, more particularly, to a spin process apparatus that may suppress generation of particles while rotating a substrate and an exhaust control method of the spin process apparatus.

2. Description of Related Art

The manufacture of semiconductor devices may involve a spin process that may be used, for example, to apply a photoresist coating, perform wet cleaning and/or perform wafer drying. Some efforts have been made to control the exhaust of a gas that may be used during a spin process. Such exhaust control techniques may enhance a completion of the spin process, for example.

According to one technique, an inverter may be installed at an exhaust fan to alter a rotation speed of the exhaust fan. In this way, an exhaust pressure may be controlled. According to another technique, a motor for rotating a substrate and a damper in an exhaust pipe line may be controlled to control an exhaust.

A trend toward smaller design rules may make it desirable to manufacture semiconductor devices with higher precision. Accordingly, semiconductor products may be affected by particles having a size on the order of microns or less, for example. During a spin process, an ascending gas flow may be generated around a substrate. The ascending gas flow may occur, for example, when the substrate is rotated at a relatively high speed. It has been reported that an ascending gas flow may be generated when a descending gas flow is driven between a bowl wall and a substrate lateral surface, and an exhaust differential pressure is insufficient.

Contaminants (such as particles, for example) may reside in the bowl. The contaminants may be lifted from the bowl by an ascending gas flow. The contaminants (which may be floating in the ascending gas flow) may land on (and become attached to) a substrate to contaminate the substrate. In case of relatively smaller and lighter particles, e.g., nano-sized particles, an ascending gas flow may have a greater effect on semiconductor devices. For this reason, substrate contamination caused by an ascending gas flow may be more prevalent in the nano-device generation.

Conventionally, an exhaust may be controlled during a spin process and thus a suitable environment may be established in a bowl to offer a desired dry environment and/or to suppress a drying of respective wafer areas to form a uniform resist layer. Although the conventional wisdom is generally thought to provide acceptable results, it is not without shortcomings. For example, conventional techniques offer no countermeasure to control particles generated by an ascending gas flow that may be generated when a substrate is rotated at a relatively high speed.

### SUMMARY

According to an example, non-limiting embodiment of the invention, an apparatus may include rotation supporting means for supporting and rotating a substrate. Shielding means may be provided for surrounding a periphery of the rotation supporting means. Sensing means may be mounted on the shielding means for sensing an ascending gas flow of a gas in the shielding means. A conduit may be coupled to the shielding means. The conduit may accommodate a flow of the gas from the shielding means. Flow control means may be provided for controlling a flow rate of the gas through the conduit. Control means may be provided for controlling the flow control means based on the ascending gas flow sensed by the sensing means.

According to another example, non-limiting embodiment of the invention, an apparatus may include a chuck to support and rotate a substrate. A bowl may surround a periphery of the chuck. A sensor may be mounted on the bowl to sense an ascending gas flow of a gas in the bowl. A conduit may be coupled to the bowl. The conduit may accommodate a flow of the gas from the bowl. A damper may be connected to the conduit to control a flow rate of the gas through the conduit. A control unit may control the damper to increase a flow rate of the gas through the conduit when the sensor senses an ascending gas flow in the bowl.

According to another example, non-limiting embodiment of the invention, a method may involve providing a substrate in a vessel where a descending gas flow of a gas is present. An ascending gas flow in the vessel may be sensed. An exhaust flow rate of the gas from the vessel may be increased when the ascending current is sensed. The exhaust flow rate of the gas from the vessel may be decreased when the ascending gas flow is not sensed.

According to another example, non-limiting embodiment of the invention, a method may be implemented for controlling an exhaust of an apparatus connected to suction means for drawing the exhaust from the apparatus. The apparatus may include rotation supporting means for supporting and rotating a substrate. Shielding means may be provided for surrounding a periphery of the rotation supporting means. Sensing means may be mounted on the shielding means for sensing an ascending gas flow of a gas in the shielding means. A conduit may be coupled to the shielding means and the suction means. The conduit may accommodate a flow of the gas from the shielding means. Flow control means may be provided for controlling a flow rate of the gas through the conduit. Control means may be provided for controlling the flow control means. The method may involve providing a substrate in the shielding means where a descending gas flow of a gas is present while rotating the substrate. An ascending gas flow in the shielding means may be sensed using the sensing means. The flow control means may be controlled using the control means when an ascending gas flow is sensed in the shielding means to increase a flow rate of the gas through the conduit. The flow control means may be controlled using the control means when an ascending gas flow is not sensed in the shielding means to decrease a flow rate of the gas through the conduit.

According to another example, non-limiting embodiment of the invention, a method may be implemented for controlling an exhaust of an apparatus connected to a pump for drawing the exhaust from the apparatus. The apparatus may include a chuck to support and rotate a substrate. A bowl may surround a periphery of the chuck. A sensor may be mounted on the bowl to sense an ascending gas flow of a gas in the bowl. A conduit may be coupled to the bowl and the pump. The conduit may accommodate a flow of the gas from the bowl. A damper may be connected to the conduit to control a flow rate of the gas through the conduit. A control unit may control the damper. The method may involve providing a substrate in the bowl where a descending gas flow of a gas is present while rotating the substrate. An ascending gas flow in the bowl may be sensed using the sensor. An open ratio of the damper may be increased using the control unit when an ascending gas flow is sensed in the bowl to increase a flow rate of the gas through the conduit. The open ratio of the damper may be decreased using the control unit when an ascending gas flow is not sensed in the bowl to decrease a flow rate of the gas through the conduit.

According to another example, non-limiting embodiment of the invention, an apparatus may include a vessel to accommodate a gas flow of a gas. A sensor may be mounted on the vessel to sense a direction of the gas flow in the vessel. A conduit may be coupled to the vessel to exhaust the gas from the vessel. A control unit may be provided to adjust a flow rate of the gas through the conduit based on the direction of the gas flow in vessel sensed by the sensor.

According to another example, non-limiting embodiment of the invention, a method may involve providing a gas flow of a gas in a vessel. A direction of the gas flow in the vessel may be sensed. The gas may be exhausted from the vessel at an exhaust flow rate. The exhaust flow rate may be adjusted based on the sensed direction of the gas flow in the vessel.

According to another example, non-limiting embodiment of the invention, a control unit may include a controller. The controller may adjust an exhaust flow rate from a vessel based on a detected direction of a gas flow in the vessel. The exhaust flow rate may be decreased when the detected direction of the gas flow in the vessel is in a first direction. The exhaust flow rate may be increased when the detected direction of the gas flow in the vessel is in a second direction that is counter to the first direction.

### BRIEF DESCRIPTION OF THE DRAWINGS

Example, non-limiting embodiments of the present invention will be readily understood with reference to the following detailed description thereof provided in conjunction with the accompanying drawings, wherein like reference numerals designate like structural elements.

FIG. 1 is a schematic view of an apparatus according to an example, non-limiting embodiment of the present invention.

FIG. 2 is a schematic view of the operation of a damper that may be implemented in the apparatus shown in FIG. 1.

FIG. 3 is a graph illustrating example gas flows that may occur within a bowl that may be implemented in the apparatus shown in FIG. 1.

FIG. 4 is a graph illustrating a relationship between the rotational speed of a substrate and the number of particles.

FIG. 5 is a graph illustrating a relationship between an exhaust differential pressure and the number of particles.

FIG. 6 is a graph illustrating the effects of increasing an exhaust differential pressure.

### DETAILED DESCRIPTION OF EXAMPLE EMBODIMENTS

Example, non-limiting embodiments of the present invention will now be described more fully with reference to the accompanying drawings. The invention may, however, be embodied in different forms and should not be construed as limited to the example embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Well-known structures and processes are not described or illustrated in detail to avoid obscuring the present invention.

An element is considered as being mounted (or provided) “on” another element when mounted (or provided) either directly on the referenced element or mounted (or provided) on other elements overlaying the referenced element. Throughout this disclosure, the terms “ascending,” “descending,” “top”, and “bottom” are used for convenience in describing various elements or portions or regions of the elements as shown in the figures. These terms do not, however, require that the structure be maintained in any particular orientation.

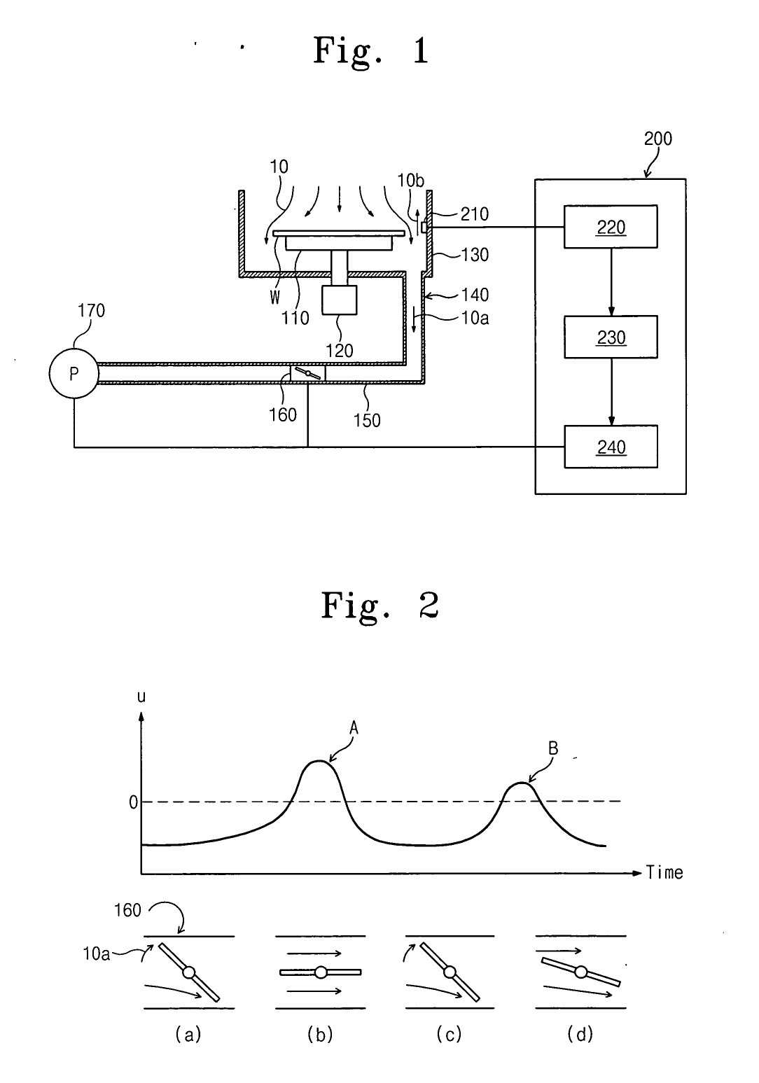

As illustrated in FIG. 1, an apparatus according to an example, non-limiting embodiment of the invention may include a chuck 110. The chuck 110 may serve as rotation supporting means. The chuck 110 may support a substrate W. A motor 120 may be provided for rotating the chuck 110. The motor 120 may be a stepping motor, for example.

The chuck 110 may be provided in a bowl 130. The bowl 130 may serve as shielding means to the extent that it may prevent dispersion of a solution supplied to a surface of the wafer W. The bowl 130 may have an open top. The bowl 130 may have a closed bottom. An exhaust port 140 may be provided in the bottom of the bowl 130. As shown, the bowl 130 may have a “C” shape. In alternative embodiments, the bowl 130 may have any other geometric shape. For example, the bowl 130 may have side walls that taper. Also, the exhaust port 140 may be located in a side wall of the bowl 130 (as opposed to the bottom of the bowl 130).

A gas (e.g., an ambient gas) may flow into the bowl 130. The gas may provide a descending gas flow 10. The gas may be removed from the bowl 130, as schematically shown by an exhaust gas flow 10a.

A sensor 210 may be mounted on a sidewall of the bowl 130. The sensor 210 may sense an ascending gas flow 10b that may be present in the bowl 130. By way of example only, the sensor 210 may be mounted on the bowl 130 at the height of the substrate W, and/or in the vicinity of the substrate W. The sensor 210 may be, for example, a 3-dimensional flow meter. The chuck 110, the motor 120, the bowl 130, and the sensor 210 may constitute a rotation treating unit for rotating a substrate W to perform a process.

A conduit 150 may be connected to the exhaust port 140 of the bowl 130. A downstream end (relative to the exhaust gas flow 10a) of the conduit 150 may be connected to a pump 170. The pump 170 may operate to draw the gas from the bowl 130 and into the conduit 150. A damper 160 may be disposed in the conduit 150. An open ratio of the damper 160 may be controlled by a control unit 200.

The control unit 200 may include a velocity meter 220. The velocity meter may display a velocity of the ascending gas flow 10b. The control unit 200 may include an actuator 240. The actuator may control an open ratio of the damper 160. The control unit 200 may include a controller 230. The controller 230 may receive information on the velocity of the ascending gas flow 10b from the velocity meter 220 to control the operation of the actuator 240.

The control unit 200 may receive a signal from the sensor 210 to determine whether there is an ascending current 10b in the bowl 130. Based on the signal from the sensor 210, the control unit 200 may regulate the open ratio of the damper 160 to control a flow rate of the exhaust gas flow 10a through the conduit 150. The control unit 200 may control the operation of the damper 160 as well as the operation of the pump 170.

The operation of the apparatus will be described in detail below.

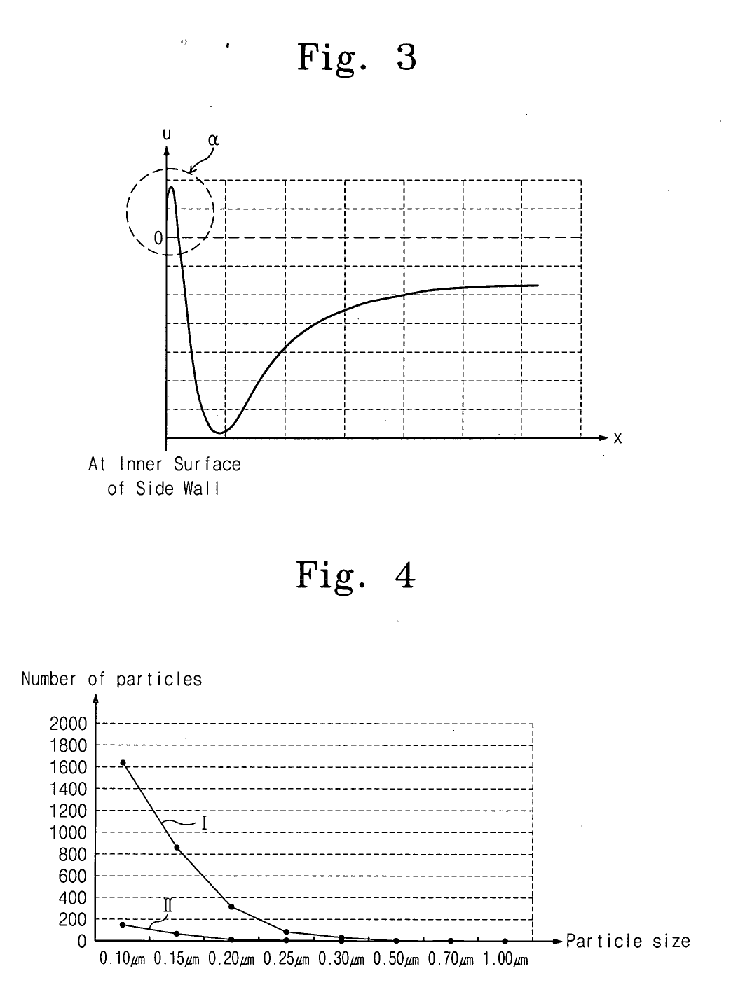

FIG. 3 is a graph illustrating the example gas flows that may occur in the bowl 130. Here, the transverse axis may denote a distance “x” from an inner surface of the sidewall of the bowl 130 to a central portion of the bowl 130. The longitudinal axis may denote a velocity “u” of a gas flow. The portion of the graph above a reference line (labeled “0”) may denote an ascending current, and the portion of the graph below the reference line (labeled “0”) may denote a descending current. When an exhaust differential pressure of the conduit 150 is not sufficiently high and a substrate W rotates at a high speed (e.g., 5,000 rpm), an ascending current region “α” may occur near the inner surface of the sidewall of the bowl 130, which may be adjacent to a lateral surface of the substrate W.

FIG. 4 is a graph illustrating a relationship between the rotational speed of the substrate and the number of particles that may contaminate the substrate. If a rotation speed of the substrate W increases from 4,000 rpm (line II) to 5,000 rpm (line I), particles (which may contaminate the substrate) may increase in number.

If the rotational speed of the substrate increases, an associated ascending gas flow may occur, which may result in an increased number of particles (e.g., micro-sized particles) being lifted from the bowl 130 and possibly contaminating the substrate. The rotational speed of the substrate may be decreased in an effort to reduce the number of potentially contaminating particles. However, some process specifications may allow for only slight variations in the rotational speed of the substrate. Accordingly, rather than lowering the rotational speed of the substrate, an exhaust differential pressure may be increased to suppress an ascending gas flow, which may reduce the number of potentially contaminating particles.

FIG. 2 schematically illustrates a relationship between a velocity “u” of a gas flow and an open ratio of the damper 160. Here, the schematic showings at (a) through (d) may denote various open states of the damper 160. Assume that a process is performed while rotating the substrate W in the bowl 130, and further assume that a gas may be directed into the bowl 130. When the pump 170 operates, the gas may be drawn from the bowl 130 and flow through the conduit 150 as the exhaust gas flow 10a. A flow rate of the exhaust gas flow 10a may depend on operations of the pump 170 and the damper 160. By way of example only, the flow rate of the exhaust gas flow 10a may be influence more by the operational state of the damper 160 than that of the pump 170.

Referring to FIG. 2, an ascending gas flow 10b may not be present in the bowl 130, and therefore it may not be detected by the sensor 210. Here, a velocity “u” of the gas flow may be below the reference line (labeled “0”). An open ratio of the damper 160 may be set by the actuator 240 to be relatively low (schematically shown at (a)).

An ascending gas flow 10b may be present in the bowl 130, and therefore it may be detected by the sensor 210. Here, the velocity “u” of the gas flow may be above the reference line (labeled “0”), as shown by region “A” of the curve. The sensor 210 may transmit a sensing signal to the controller 230. In response, the controller 230 may activate the actuator 240, which in turn may operate to increase an open ratio of the damper 160 (as schematically shown at (b)). In this way, the flow rate of the exhaust gas flow 10a may increase and an exhaust differential pressure may rise to reduce the velocity “u” of the ascending gas flow 10b.

The ascending gas flow 10b in the bowl 130 may diminish and disappear with an increase in the flow rate of the exhaust gas flow 10a. Accordingly, the sensor 210 may not detect an ascending current. Thus, the actuator 240 may operate by means of the controller 230 to decrease the open ratio of the damper 160 (as schematically shown at (c)).

The ascending gas flow 10b may reappear in the bowl 130, as shown by region “B” of the curve. Here, the sensor 210 may detect the ascending gas flow 10b and transmit a sensing signal to the controller 230, which in turn may activate the actuator 240, which in turn may operate to increase the open ratio of the damper 160 (as schematically shown at (d)). In this way, the exhaust differential pressure may rise to reduce the velocity “u” of the ascending gas flow 10b.

In some situations, an ascending gas flow in the bowl 130 may not disappear when the open ratio of the damper 160 is increased. In this case, the control unit 200 may further increase the flow rate of the exhaust gas flow 10a by increasing an output of the pump 170.

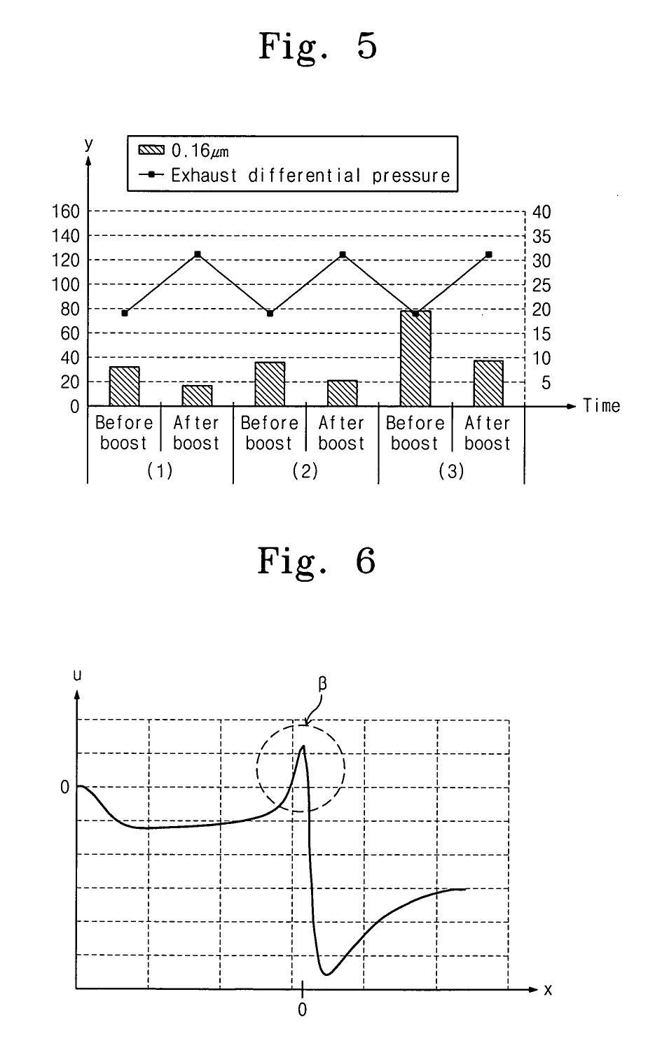

FIG. 5 is a graph illustrating a relationship between an exhaust differential pressure and the number of particles that may contaminate the wafer. In FIG. 5, (1), (2), and (3) indicated along the transverse axis may be serial numbers associated with respective spin process, which may be set at random, for example. A left-side longitudinal axis may denote the number of potentially contaminating particles and a right-side longitudinal axis may denote an exhaust differential pressure (mmH₂O). As illustrated in FIG. 5, if an exhaust differential pressure rises by virtue of increasing a flow rate of the exhaust gas flow 10a, the number of particles (0.16 micrometer) that become attached to a wafer may decrease.

FIG. 6 is a graph illustrating the effects of increasing an exhaust differential pressure. In FIG. 6, the point “0” on the transverse axis may denote an outside boundary portion of the bowl, to the right of the point “0” may denote the inner side of the bowl and to the left of the point “0” may denote the outer side of the bowl. A region “β” of the curve may represent an ascending current at the outside boundary portion (i.e., located at point “0”). If an exhaust differential pressure rises, the portion of the curve to the left of the point “0” falls (indicating a higher descending gas flow velocity on the outside of the bowl), thereby influencing contaminated air to flow along the outside of the bowl and not into the bowl.

In the example embodiments, the apparatus may include only a single exhaust port 140. In alternative embodiments, the apparatus may include multiple exhaust ports 140. In the example embodiments, the control unit 200 may include a velocity meter 220, a controller 230 and an actuator 240. In alternative embodiments, the control unit 200 may implement numerous alternative components to achieve the desired functionality. Further, the velocity meter 220 need not display the velocity of the ascending gas flow.

Numerous modifications and variations to the basic inventive concepts will be apparent to a person skilled in the art from the foregoing disclosure. Thus, while only certain example, non-limiting embodiments of the invention have been specifically described, it will be apparent that numerous modifications may be made thereto without departing from the spirit and scope of the invention, as defined in the appended claims.

What is claimed is:

1. An apparatus comprising:
rotation supporting means for supporting and rotating a substrate;
shielding means for surrounding a periphery of the rotation supporting means;
sensing means mounted on the shielding means for sensing an ascending gas flow of a gas in the shielding means;
a conduit, coupled to the shielding means, the conduit to accommodate a flow of the gas from the shielding means;
flow control means for controlling a flow rate of the gas through the conduit; and
control means for controlling the flow control means based on the ascending gas flow sensed by the sensing means.

2. The apparatus of claim 1, wherein the control means controls the flow control means to increase a flow rate of the gas through the conduit when the sensing means senses an ascending gas flow in the shielding means.

3. The apparatus of claim 1, wherein the control means controls the flow control means to decrease a flow rate of the gas through the conduit when the sensing means does not sense an ascending gas flow in the shielding means.

4. The apparatus of claim 1, further comprising:
suction means coupled to the conduit for drawing the gas from the shielding means and through the conduit,
wherein the control means controls the suction means.

5. An apparatus comprising:
a chuck to support and rotate a substrate;
a bowl surrounding a periphery of the chuck;
a sensor mounted on the bowl to sense an ascending gas flow of a gas in the bowl;
a conduit coupled to the bowl, the conduit to accommodate a flow of the gas from the bowl;
a damper connected to the conduit to control a flow rate of the gas through the conduit; and
a control unit to control the damper to increase a flow rate of the gas through the conduit when the sensor senses an ascending gas flow in the bowl.

6. The apparatus of claim 5, wherein the control unit controls the damper to decrease a flow rate of the gas through the conduit when the sensor does not sense an ascending gas flow in the bowl.

7. The apparatus of claim 5, wherein the control unit comprises:
a velocity meter to receive information on an ascending gas flow in the bowl, the velocity meter displaying a velocity of the ascending gas flow;
an actuator for controlling an open ratio of the damper; and
a controller to control the operation of the actuator.

8. The apparatus of claim 7, further comprising:
a pump coupled to the conduit to draw the gas from the bowl and through the conduit,
wherein the controller controls the pump.

9. The apparatus of claim 5, wherein the sensor is mounted on the bowl at the height of a substrate placed on the chuck.

10. A method comprising:
providing a substrate in a vessel where a descending gas flow of a gas is present;
sensing an ascending gas flow in the vessel;
increasing an exhaust flow rate of the gas from the vessel when the ascending current is sensed; and
decreasing the exhaust flow rate of the gas from the vessel when the ascending gas flow is not sensed.

11. A method for controlling an exhaust of an apparatus connected to suction means for drawing the exhaust from the apparatus, the apparatus including rotation supporting means for supporting and rotating a substrate, shielding means for surrounding a periphery of the rotation supporting means, sensing means mounted on the shielding means for sensing an ascending gas flow of a gas in the shielding means, a conduit coupled to the shielding means and the suction means, the conduit to accommodate a flow of the gas from the shielding means, flow control means for controlling a flow rate of the gas through the conduit, and control means for controlling the flow control means, the method comprising:
providing a substrate in the shielding means where a descending gas flow of a gas is present while rotating the substrate;
sensing an ascending gas flow in the shielding means using the sensing means;
controlling the flow control means using the control means when an ascending gas flow is sensed in the shielding means to increase a flow rate of the gas through the conduit; and
controlling the flow control means using the control means when an ascending gas flow is not sensed in the shielding means to decrease a flow rate of the gas through the conduit.

12. The method of claim 11, further comprising:
controlling the suction means using the control means.

13. A method for controlling an exhaust of an apparatus connected to a pump for drawing the exhaust from the apparatus, the apparatus including a chuck to support and rotate a substrate, a bowl surrounding a periphery of the chuck, a sensor mounted on the bowl to sense an ascending gas flow of a gas in the bowl, a conduit coupled to the bowl and the pump, the conduit to accommodate a flow of the gas from the bowl; a damper connected to the conduit to control a flow rate of the gas through the conduit; and a control unit to control the damper, the method comprising:
providing a substrate in the bowl where a descending gas flow of a gas is present while rotating the substrate;
sensing an ascending gas flow in the bowl using the sensor;
increasing an open ratio of the damper using the control unit when an ascending gas flow is sensed in the bowl to increase a flow rate of the gas through the conduit; and
decreasing the open ratio of the damper using the control unit when an ascending gas flow is not sensed in the bowl to decrease a flow rate of the gas through the conduit.

14. The method of claim 13, further comprising:
increasing an output of the pump using the control unit when the ascending gas flow is sensed in the bowl to increase the flow rate of the gas through the conduit.

15. An apparatus comprising:
a vessel to accommodate a gas flow of a gas;
a sensor mounted on the vessel to sense a direction of the gas flow in the vessel;
a conduit coupled to the vessel to exhaust the gas from the vessel; and
a control unit that adjusts a flow rate of the gas through the conduit based on the direction of the gas flow in vessel sensed by the sensor.

16. The apparatus of claim 15, wherein the control unit increases the flow rate of the gas through the conduit when the sensor senses a gas flow away from the conduit.

17. The apparatus of claim 15, wherein the control unit decreases the flow rate of the gas through the conduit when the sensor does not sense a gas flow away from the conduit.

18. A method comprising:
providing a gas flow of a gas in a vessel;
sensing a direction of the gas flow in the vessel;
exhausting the gas from the vessel at an exhaust flow rate; and
adjusting the exhaust flow rate based on the sensed direction of the gas flow in the vessel.

19. The method of claim 18, wherein adjusting the exhaust flow rate comprises:
increasing the exhaust flow rate when the sensed direction of the gas flow in the vessel is in a first direction; and
decreasing the exhaust flow rate when the sensed direction of the gas flow in the vessel is in a second direction that is counter to the first direction.
